(19) United States
(12) Patent Application Publication
(10) Pub. No.: US 2004/0047034 A1
(43) Pub. Date: Mar. 11, 2004

(54) Safety illumination system for surgical microscopes

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 10/653,488

(22) Filed: Sep. 2, 2003

(30) Foreign Application Priority Data
Sep. 6, 2002 (DE) 102 41 261.8

(51) Int. Cl. G02B 21/06

(52) U.S. Cl. 359/385

(57) ABSTRACT

The invention concerns an ophthalmic surgical microscope having an illuminating beam (13), reflected into the observation beam path, which is pulsed and/or scanned in order to reduce stress on a tissue, in particular a patient's eye, located in the object field (11).

### CROSS REFERENCE TO RELATED APPLICATIONS

This application claims priority of the German patent application 102 41 261.8 filed Sep. 6, 2002 which is incorporated by reference herein.

### FIELD OF THE INVENTION

Surgical microscopes emit very bright light in order to illuminate the surgical field. In eye surgery, this can result in damage to the retina or cornea of the patient's eye. Intensive efforts have been made to prevent this.

### BACKGROUND OF THE INVENTION

The following possibilities are known from the existing art:

U.S. Pat. No. 4,715,704 discloses a retina stop under the name of a so-called “light trap.” An opaque stop in the illumination beam path is imaged into the object field, where it darkens the central portion of the illuminated field. The surgeon must orient the patient's eye in such a way that it ends up located in this darkened region. This is impractical in terms of surgical procedure, and the surgeon's view is restricted.

DE-A1-195 38 382 discloses a safety device that, by way of a distance measurement, reduces the brightness, switches off the illumination, or emits a warning sound or signal as soon as the distance to the patient's eye becomes too short with the illumination switched on. Protection of the patient's eye thus comes, however, at the cost of a reduction in illuminated field brightness.

DE-A-101 08 254 has presented a further safety apparatus that reduces the light intensity using filters with a spectrally selective effect. These filters modify the color impression of the illuminating light, however, which in some circumstances can be undesirable.

A combination of a microscope with a stroboscope is additionally provided in U.S. Pat. No. 4,948,247, but it is designed to generate a stationary image of moving subjects, and not additionally to protect patients' eyes.

The following object therefore has not hitherto been optimally achieved: on the one hand the patient field must be illuminated very brightly; on the other hand, as little light as possible must be incident on the patient's eye.

### SUMMARY OF THE INVENTION

It was therefore the object of the present invention to arrive, in the context of this contradiction, at the most efficient protection possible along with the best possible illumination.

The inventor has recognized that this contradiction can be resolved using the following ideas according to the present invention:

It is not necessary to use a light source radiating continuously over time; a certain pulsed light radiation is sufficient for the same perception of the illumination. Pulsed light radiation, however, means less energy input into the eye. This is because according to the Talbot-Plateau law, periodic light stimuli in rapid succession above the critical flicker frequency evoke the same sensation as a continuous stimulus in which the light quantity present in the periodic stimuli is distributed uniformly over the entire time (H. Schober, “Das Sehen” [Vision], Vol. II, Leipzig 1958).

For short-duration light stimuli, what is critical in terms of the operator's sensation is therefore the product of the retinal illumination intensity and stimulus duration in the observer's (surgeon's) eye, and correspondingly the product of the luminous flux and stimulus duration, i.e. the light quantity. According to Schober, it is immaterial whether the bright periods and dark periods are identical to one another or of different lengths; the only condition is that the critical flicker frequency be exceeded.

As the relative length of the dark period increases, the light impression merely becomes weaker in accordance with the decreasing stimulus duration within the overall time, but the Talbot-Plateau law is still obeyed.

According to the present invention, this realization, known per se, is now exploited so that less light energy in total strikes the patient's eye and it is therefore not stressed, but the observer obtains sufficient stimulus information for his or her eye. The present invention therefore utilizes a side-effect of the Talbot-Plateau law in such a way that while the perception by the observer remains the same or approximately the same, less light energy is available for illumination of the patient's eye and the latter is therefore not stressed.

An inventive idea that is similar at first glance is implemented in U.S. Pat. No. 4,782,386, which provides for stroboscopic illumination for an endoscope in order (probably) to reduce heating of the illuminated tissue by a conventional, hotter lamp. The apparatus is disclosed only in combination with a camera, however, and makes no reference to the conditions of an observer's eye and still less to those of a patient's eye, or to the process by which an observer's eye views a patient's eye.

The Daimler-Chrysler News of Apr. 5, 2000 presented a system for reducing the dazzle effect while driving a car, which system combines a pulsed laser light as an (additional) headlight with a video camera for observation of the road. The driver obtains, in addition to the image actually seen, an image superimposed by the video camera that was acquired during the bright periods of the laser light headlight.

The present invention concerns, however, not exploitation of the pulsing properties of an additional infrared laser light, as described by Daimler-Chrysler, but rather reduction of the light energy of the illumination itself that is incident directly into the patient's eye, with a simultaneous sufficient reduction in stimulus generation in the observer's eye. Daimler-Chrysler, on the other hand, discloses only an additional camera-controlled system that allows the normal illumination to be kept low.

According to an embodiment of the present invention, the pulsed illuminating beam can also be generated by the fact that a conventional illumination system, whose illuminating beam is pulsed by means of a shutter wheel, is used.

The shutter for this can be embodied electromechanically, or can be an optoelectronic, e.g. electrochromic or LCD shutter.

A further embodiment of the invention emits less light energy into the patient's eye by the fact that the light of a laser (e.g. white-light laser) is scanned into the patient's eye. As long as the scan repetition frequency is higher than the critical flicker frequency of the observer's eye, with this technique as well the observer perceives an undiminished illumination while energy delivery into the patient's eye is decreased. Scanning of the laser beam can occur in this context both by means of an optomechanical mirror but also by means of a fixed two-dimensional reflective display (also called a “micromirror”), which makes use of nanotechnology to cause the laser beam, or any light beam, to move as the individual mirror segments successively transition into the active mirror mode.

In addition to this technology just described, the laser beam can also be pulsed, either inherently or by means of a shutter, thereby also creating a further possibility for decreasing the energy delivery into the patient's eye.

If what is used is a micromirror, which utilizes tiny submirrors set one behind another to cause the laser beam to move, a conventional illumination source that irradiates the micromirror in extended-area fashion is also conceivable.

Additionally falling within the context of the disclosure of this application is the combination of a previously pulsed light (generated either by a stroboscope or by way of a chopped or shuttered continuous light) with an optomechanical mirror or a micromirror. A decrease in energy delivery into the patient's eye would accordingly be brought about both by the pulsing and by the scanning.

All of the safety illumination systems herewith disclosed are intended to be used both for afocal systems (beam paths passing through a common main objective) and for systems according to Greenough (separate objectives for each stereoscopic beam path).

Further embodiments of the invention are described in the Figures and in the claims.

The Parts List is a constituent part of the disclosure.

### BRIEF DESCRIPTION OF THE DRAWINGS

The invention will be explained in more detail, symbolically and by way of example, with reference to Figures. The Figures are described in interconnected and overlapping fashion. Identical reference characters denote identical components; reference characters having different indices refer to functionally identical components. In the Figures:

FIG. 1a is a diagram of a radiation, continuous over time, from a conventional light source;

FIG. 1b is a diagram of a pulsed radiation;

FIG. 2a shows a schematic configuration of an exemplary embodiment of a microscope according to the present invention having a conventional illumination system;

FIG. 2b shows a schematic configuration of an exemplary embodiment of a microscope according to the present invention having a stroboscopic lamp;

FIG. 2c shows a schematic configuration of an exemplary embodiment of a microscope according to the present invention having a laser and an optomechanical mirror;

FIG. 2d shows a schematic configuration of an exemplary embodiment of a microscope according to the present invention having a laser and a micromirror;

FIG. 2e shows a schematic configuration of an exemplary embodiment of a microscope according to the present invention having a conventional illumination system and a micromirror; and

FIG. 2f shows a schematic configuration of an exemplary embodiment of a microscope according to the present invention having a stroboscopic lamp and a micromirror.

### DETAILED DESCRIPTION OF THE INVENTION

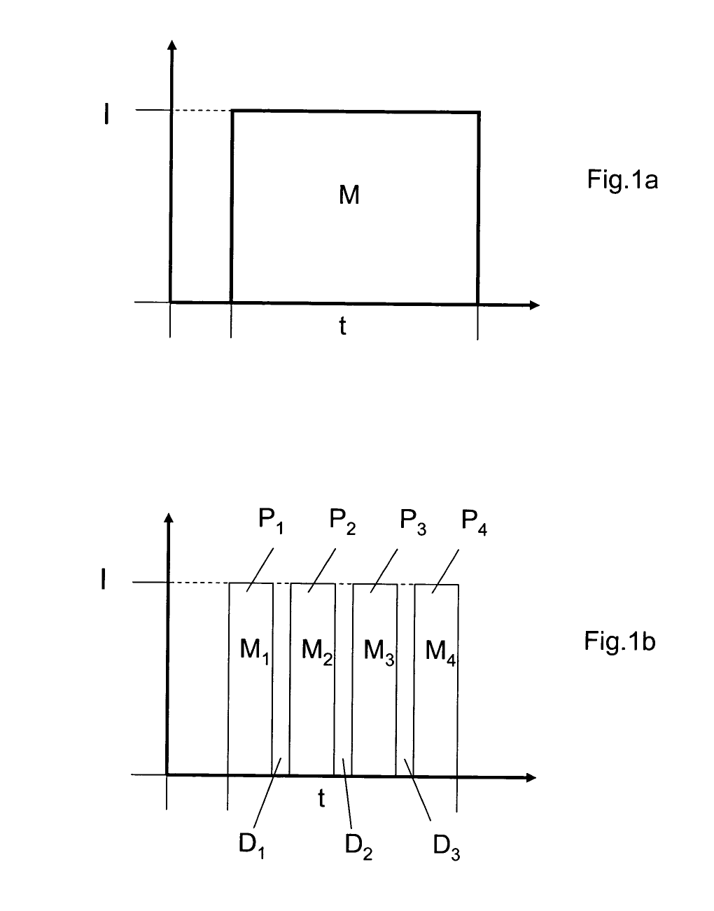

The diagram in FIG. 1 a depicts the radiation of a conventional light source, time being plotted on the X axis and the radiation intensity on the Y axis. It is evident from this that the radiation of a conventional light source occurs at a constant intensity I over an entire time interval t. The product I×t thus yields the light quantity M.

FIG. 1b is a diagram of the radiation of a pulsed light source in the context of which, over the same time interval t, four bright periods P₁- P₄ of identical intensity I alternate with three dark periods D₁-D₃. The values depicted would yield a sum of the partial light intensities M₁+M₂+M₃+M₄ that is 3/7 less than light quantity M. Based on the findings of Talbot and Plateau, however, this reduction does not lead to a reduction in the visual stimulus in the viewer's eye, provided the frequency is higher than the critical flicker frequency. Despite the smaller light quantity in FIG. 1b, the observer therefore sees just as much as with an illumination according to FIG. 1a.

In the form depicted, bright periods Pₓ and dark periods Dₓ are not symmetrical, i.e. in the form depicted, the bright periods last longer than the dark periods. If the intervals were of identical duration, i.e. of identical width on time axis t, they would be depicted symmetrically. As already mentioned, however, this is immaterial in terms of perception of a supposedly continuous light having a light quantity M=M₁+M₂+M₃+M₄, as long the “flickering” of the bright periods lies above the physiological critical flicker frequency.

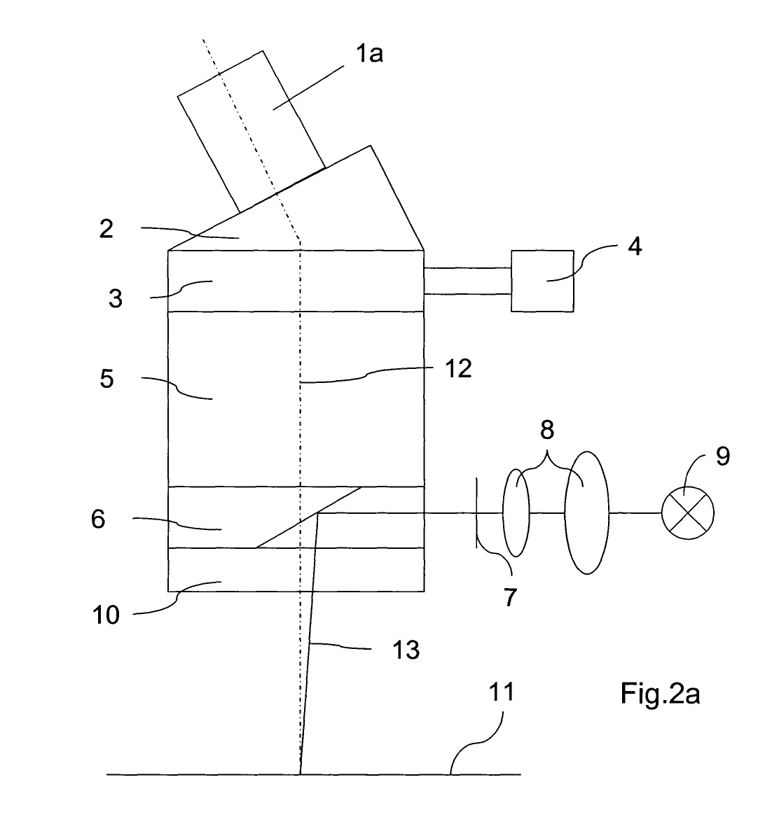

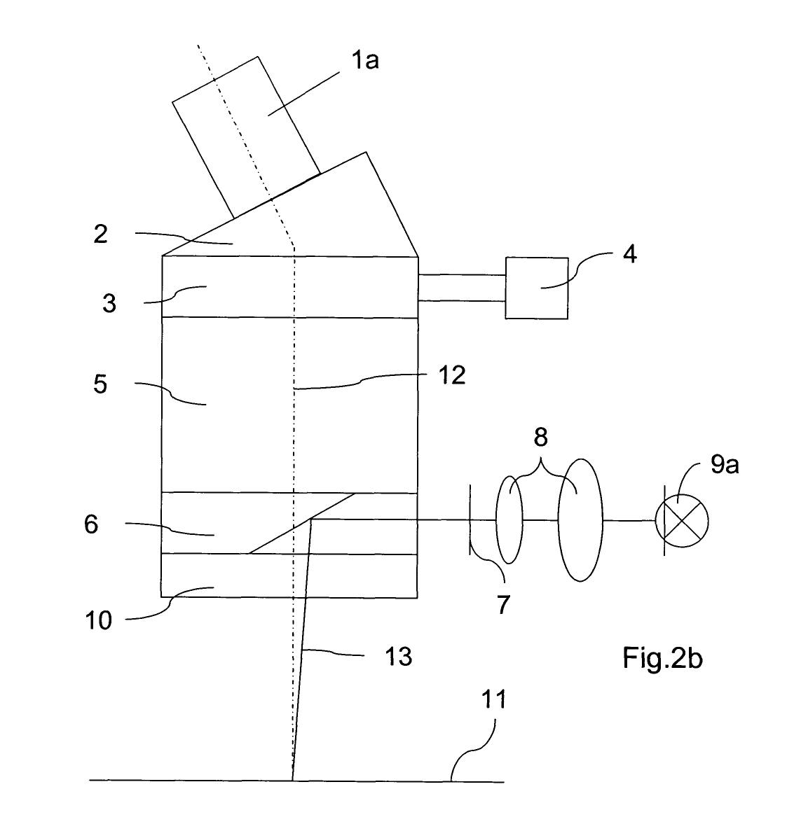

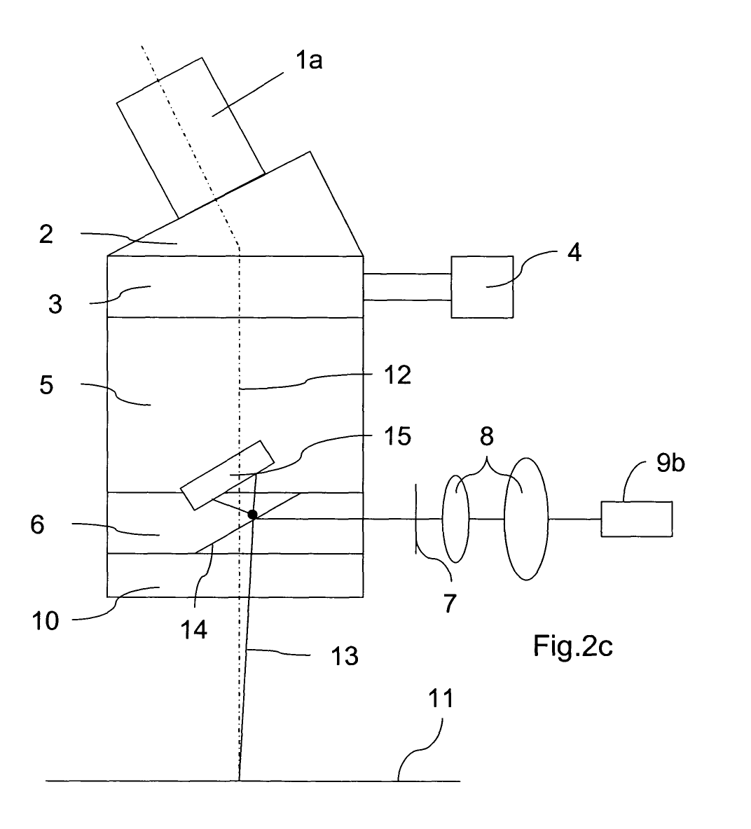

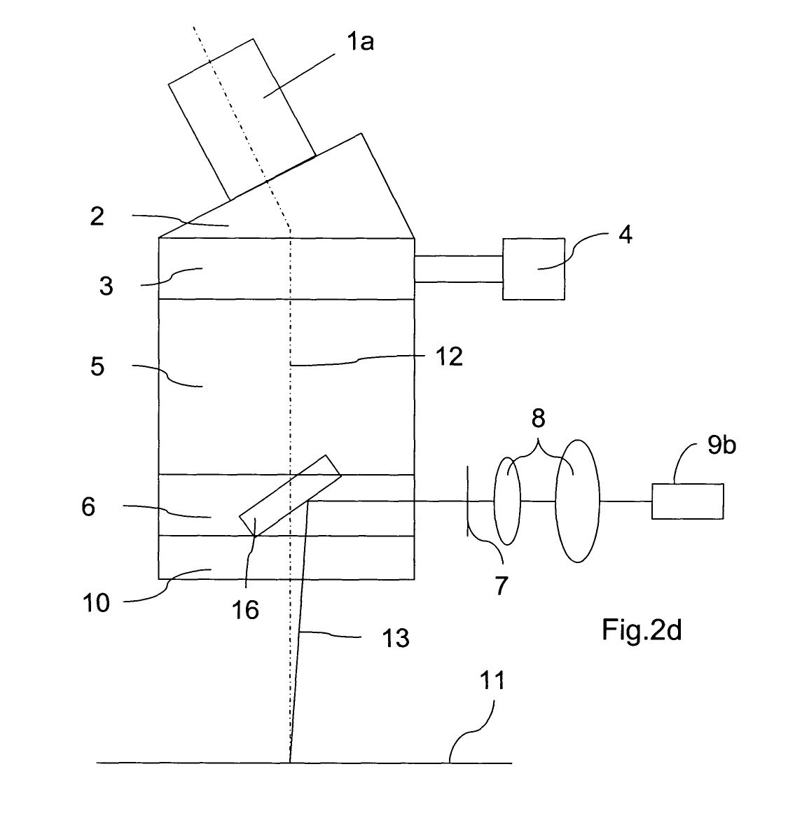

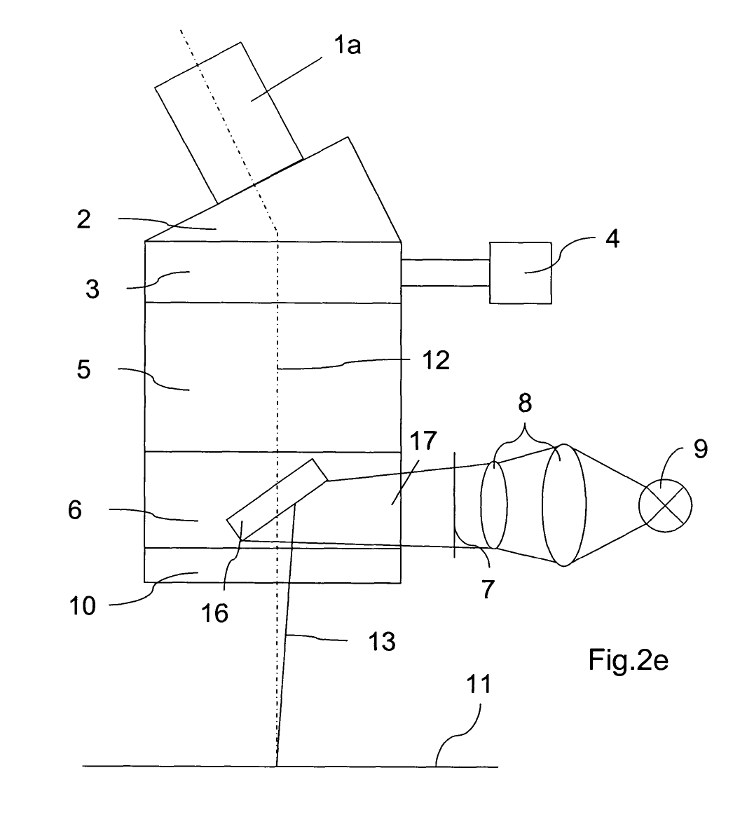

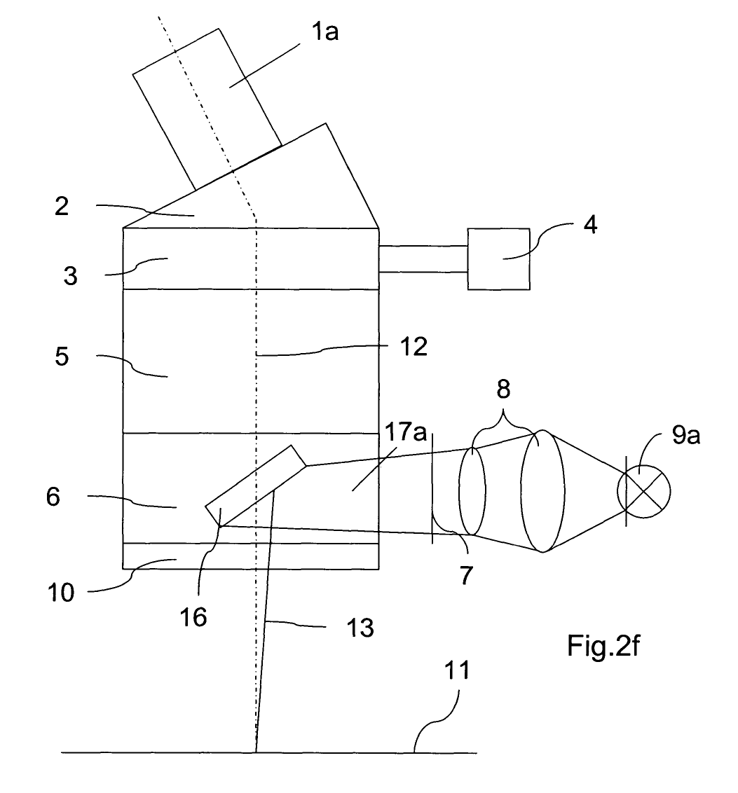

FIG. 2a depicts the schematic configuration of a surgical microscope according to the present invention. An observation beam path with axis 12 is guided through a binocular tube 2 having eyepieces 1a, b (eyepiece 1b concealed), an optical splitter 3 (into which an optional camera 4 is integrated), an (optional) zoom 5, an illumination unit 6, and a main objective 10. In the case of a stereoscopic embodiment of the microscope, the right and left observer beam paths lie behind one another in the schematic side view used for all the drawings. A pulsed illuminating beam 13 is reflected through main objective 10 into this observation beam path by means of illumination unit 6. Lamp 9 emits the illuminating light that is imaged through illumination optical system 8 into object field 11, in which, for example, the patient's eye under observation is located. In the present case, the pulsing of light beam 13 is generated by a shutter 7. If a stroboscopic lamp 9a is used instead of a continuously radiating lamp 9, installation of the shutter wheel is in principle superfluous, but should not be ruled out for optimization of the stroboscope illumination.

The advantage of a conventional illumination system that is cycled by means of a shutter wheel lies in its good light quality, characterized by a spectral region adapted for visual observation. The additional use here of cycled or continuous lamps having non-visible spectral regions is explicitly not excluded in this context.

The interpenetration of the observer and illumination beam paths depicted in all the drawings is not absolutely necessary. Conceivable exemplary embodiments also present a partial penetration or even a strict separation of the two beam paths.

FIG. 2b depicts the same configuration of a microscope as in FIG. 2a, the only difference being that instead of conventional illumination system 9, a stroboscopic lamp 9a generates the pulsed illumination. Installation of shutter 7 is optional.

FIG. 2c schematically depicts the fact that in this case a laser 9b, e.g. a white-light laser, assumes the illumination function and directs its collimated light beam onto an optomechanical mirror 14. Optomechanical mirror 14 is moved by means of motor 15 so precisely that the reflected light beam 13 performs a scanning motion. If the scan cycles follow one another so rapidly that the resulting frequency is higher than the critical flicker frequency, an observer perceives through binocular tube 2 an undiminished illumination of object field 11. Installation of illumination optical system 8 and shutter 7 is optional.

FIG. 2d shows a configuration having a laser 9b and a symbolically depicted micromirror 16 which generates the scanning motion of light beam 13. Here again, installation of illumination optical system 8 and shutter 7 is optional.

FIG. 2e depicts a configuration having a conventional illumination system 9, illumination optical system 8, and an optional shutter, 7. It is evident here that a collimated light beam is not required for micromirror 16, but rather that extended-area illumination is performed with a pencil of light 17, and that scanning of light beam 13 in object field 11 is accomplished by successive activation of the individual mirror elements of micromirror 16.

FIG. 2f shows that pencil of light 17 can also strike the micromirror in pulsed fashion, as a result of pulse generation by either stroboscopic lamp 9a or shutter 7 or both, so that a pulsed light beam performs the scanning motion.

An external image generator (not shown) can also be associated with optical splitter 3 for reflecting image information into the observation beam path along axis 12, wherein the reflected-in image information is pulsed at the same frequency in synchronization with the illuminating beam.

PARTS LIST

| | |
|---|---|
| 1a, b | Eyepiece |
| 2 | Binocular tube |
| 3 | Optical splitter |
| 4 | Camera |
| 5 | Zoom |
| 6 | Illumination unit |
| 7 | Shutter |
| 7a | Shutter wheel |
| 7b | Electrochromic shutter |
| 8 | Illumination optical system |
| 9 | Lamp |
| 9a | Stroboscopic lamp |
| 9b | Laser |
| 10 | Main objective |
| 11 | Object field |
| 12 | Axis of observation beam path |
| 13 | Illuminating beam |
| 14 | Optomechanical mirror |
| 15 | Motor |
| 16 | Micromirror |
| 17 | Pencil of light |
| 17a | Pulsed pencil of light |
| I | Intensity |
| t | Time interval |
| M | Light quantity |
| M_{1,2,3,4} | Partial light quantity |
| P_{1,2,3,4} | Bright period |
| D_{1,2,3} | Dark period |

What is claimed is:

1. A surgical microscope for observing an object field, the surgical microscope comprising:
an observation beam path along which the object field is observed; and
means for providing an illuminating beam for illuminating the object field, wherein the illuminating beam is pulsed.

2. A surgical microscope for observing an object field, the surgical microscope comprising:
an observation beam path along which the object field is observed; and
means for providing an illuminating beam for illuminating a small area of the object field at a given time, wherein the illuminating beam is scanned over the object field.

3. A surgical microscope for observing an object field, the surgical microscope comprising:
an observation beam path along which the object field is observed; and
means for providing an illuminating beam for illuminating a small area of the object field at a given time, wherein the illuminating beam is scanned over the object field and is pulsed.

4. The surgical microscope as defined in claim 1, wherein the illuminating beam is pulsed at a pulse frequency exceeding the critical flicker frequency of an observer's eye.

5. The surgical microscope as defined in claim 1, wherein the illuminating beam is pulsed at a pulse frequency not less than 60 Hertz.

6. The surgical microscope as defined in claim 2, wherein the illuminating beam is scanned at a scanning frequency exceeding the critical flicker frequency of an observer's eye.

7. The surgical microscope as defined in claim 2, wherein the illuminating beam is scanned at a scanning frequency not less than 60 Hertz.

8. The surgical microscope as defined in claim 3, wherein the illuminating beam is pulsed at a pulse frequency exceeding the critical flicker frequency of an observer's eye and is scanned at a scanning frequency exceeding the critical flicker frequency of the observer's eye.

9. The surgical microscope as defined in claim 3, wherein the illuminating beam is pulsed at a pulse frequency not less than 60 Hertz and is scanned at a scanning frequency not less than 60 Hertz.

10. The surgical microscope as defined in claim 1, wherein the means for providing a pulsed illuminating beam includes a stroboscopic lamp.

11. The surgical microscope as defined in claim 3, wherein the means for providing a pulsed and scanned illuminating beam includes a stroboscopic lamp.

12. The surgical microscope as defined in claim 2, wherein the means for providing a scanned illuminating beam includes a laser whose beam is steered over the object field in scanning steps.

13. The surgical microscope as defined in claim 3, wherein the means for providing a pulsed and scanned illuminating beam includes a laser whose beam is steered over the object field in scanning steps.

14. The surgical microscope as defined in claim 2, wherein the means for providing a scanned illuminating beam includes at least one micromirror for scanning.

15. The surgical microscope as defined in claim 3, wherein the means for providing a pulsed and scanned illuminating beam includes at least one micromirror for scanning.

16. The surgical microscope as defined in claim 1, wherein the means for providing a pulsed illuminating beam includes a light source and a shutter after the light source.

17. The surgical microscope as defined in claim 3, wherein the means for providing a pulsed and scanned illuminating beam includes a light source and a shutter after the light source.

18. The surgical microscope as defined in claim 16, wherein the shutter comprises a shutter wheel or an electrochromic shutter.

19. The surgical microscope as defined in claim 17, wherein the shutter comprises a shutter wheel or an electrochromic shutter.

20. The surgical microscope as defined in claim 1, wherein the dark periods of the pulsed illuminating beam are symmetrical with respect to the bright periods.

21. The surgical microscope as defined in claim 1, wherein the dark periods of the pulsed illuminating beam are not symmetrical with respect to the bright periods.

22. The surgical microscope as defined in claim 1, further comprising a measuring apparatus for counting the number of light pulses of the pulsed illuminating beam and means for reporting the number of light pulses.

23. The surgical microscope as defined in claim 1, further comprising a measuring apparatus for measuring the intensity of light pulses of the pulsed illuminating beam and means for reporting the measured intensity.

24. The surgical microscope as defined in claim 1, further comprising a CCD camera connected to the observation beam path via a beam splitter.

25. The surgical microscope as defined in claim 2, further comprising a CCD camera connected to the observation beam path via a beam splitter.

26. The surgical microscope as defined in claim 3, further comprising a CCD camera connected to the observation beam path via a beam splitter.

27. The surgical microscope as defined in claim 24, wherein the readout frequency of the CCD camera is synchronized with the pulse frequency of the illuminating beam.

28. The surgical microscope as defined in claim 25, wherein the readout frequency of the CCD camera is synchronized with the scanning frequency of the illuminating beam.

29. The surgical microscope as defined in claim 26, wherein the readout frequency of the CCD camera is synchronized with at least one of the pulse frequency and the scanning frequency of the illuminating beam.

30. The surgical microscope as defined in claim 1, further comprising means for reflecting external image information into the observation beam path, wherein the reflected-in image information is pulsed in synchronization with the illuminating beam.

31. The surgical microscope as defined in claim 1, wherein said surgical microscope is an ophthalmic surgical microscope.

32. The surgical microscope as defined in claim 1, wherein said surgical microscope comprises an afocal beam path.

33. The surgical microscope as defined in claim 1, wherein said surgical microscope comprises a beam path according to the Greenough system.
